(19) United States
(12) Patent Application Publication
(10) Pub. No.: US 2010/0258504 A1
(43) Pub. Date: Oct. 14, 2010

(54) FABRICATION OF ASYMMETRIC POLYSULFONE MEMBRANE FOR DRINKING WATER PURIFICATION

(75) Inventors: Zularisam AB WAHID, Gambang (MY); Mimi Sakinah ABDUL MUNAIM, Gambang (MY)

Correspondence Address: Workman Nydegger;1000 Eagle Gate Tower, 60 East South Temple, Salt Lake City, UT, 84111, US

(73) Assignee: UNIVERSITI MALAYSIA PAHANG, Gambang (MY)

(21) Appl. No.: 12/755,560

(22) Filed: Apr. 7, 2010

(30) Foreign Application Priority Data
Apr. 8, 2009 (MY) PI 20091409

(51) Int. Cl. B01D 71/06; C02F 1/44; B01D 71/56; B01D 71/68

(52) U.S. Cl. 210/650; 210/500.38

(57) ABSTRACT

The present invention provides a bio-membrane formulation to be used to eliminate microorganism, turbidity, suspended particles and organic matters from drinking water wherein the bio-membrane includes a polysulfone with a concentration of 15%-18%, N,N-dimethylacetamide of 65%-70% and poly (vinyl-pyrolidone)-K30 at 10%-15%.

### FIELD OF INVENTION

The present invention relates to asymmetric polysulfone (PSF) membrane fabrication that is used for drinking water purification.

### BACKGROUND OF INVENTION

Presence of potential bacteria and viruses enteric, undesirable colour, tastes and odours in drinking water resulting from cross contamination of rust, slit, scale, mud, microorganisms and colloidal materials require an extra post-treatment process for safer portable water consumption.

Hence, there is a need for a polymer membrane filter which overcomes these problems.

### SUMMARY OF INVENTION

Accordingly, the present invention provides a bio-membrane formulation to be used to eliminate microorganism, turbidity, suspended particles and organic matters from drinking water wherein the bio-membrane includes a polysulfone with a concentration of 15%-18%, N,N-dimethylacetamide of 65%-70% and poly (vinyl-pyrolidone)-K30 at 10%-15%.

The present invention consists of several novel features and a combination of parts hereinafter fully described and illustrated in the accompanying description and drawing, it being understood that various changes in the details may be made without departing from the scope of the invention or sacrificing any of the advantages of the present invention.

### BRIEF DESCRIPTION OF THE DRAWINGS

The present invention will be fully understood from the detailed description given herein below and the accompanying drawings which are given by way of illustration only, and thus are not limitative of the present invention, wherein:

FIG. 1 shows the bio-membrane SEM morphology;

FIG. 2 shows a stirring container;

FIG. 3 shows schematic diagram of hollow fiber bio-membrane spinning rig;

FIG. 4 bio-membrane's zeta potential;

FIG. 5 shows typical dry/wet spinning process;

FIG. 6 shows the bio-membrane molecular weight cut-off (MWCO) profiles;

### DETAILED DESCRIPTION OF THE PREFERRED EMBODIMENTS

The present invention relates to asymmetric polysulfone membrane fabrication that is used for drinking water purification. Hereinafter, this specification will describe the present invention according to the preferred embodiments of the present invention. However, it is to be understood that limiting the description to the preferred embodiments of the invention is merely to facilitate discussion of the present invention and it is envisioned that those skilled in the art may devise various modifications and equivalents without departing from the scope of the appended claims.

The present invention provides an asymmetric ultrafiltration hollow fiber membrane to treat potable water supply of poor water quality. The main principal advantages of this membrane are ability to supply higher quality of potable water (surpassing national drinking water standards) that is totally free from colloidal, suspended solids and bacterial contamination.

The bio-membrane is synthesized from phase inversion technique using a dry-wet spinning machine. This membrane is fabricated from a dope formulation containing polysulfone polymer, additives and N-dimethylacetamide (DMAc) solvent.

The bio-membrane is used to ensure better membrane performance in terms of quality and productivity compared to the commercially available water filter.

The bio-membrane is 83 times better in term of separation performance than the conventional house-hold membrane filter. This is due to its smaller pore size (approximately 6 nm or 68 kDa) compared to the commercially available filters (0.5 μm to 5 μm). Its 6 nm pore size, which is 16 times smaller than the bacteria's diameter (100 nm) ensures 99.99% bacterial rejection.

Besides that, its low energy consumption of 1 bar and more economical membrane filter compared to the commercial filter, bio-membrane permeation rate has been made to sufficient the flow of normal tap water flow rate from 15 L/min to 20 L/min and stays more durable within 5 years by manipulating the exclusive membrane recipe during membrane fabrication.

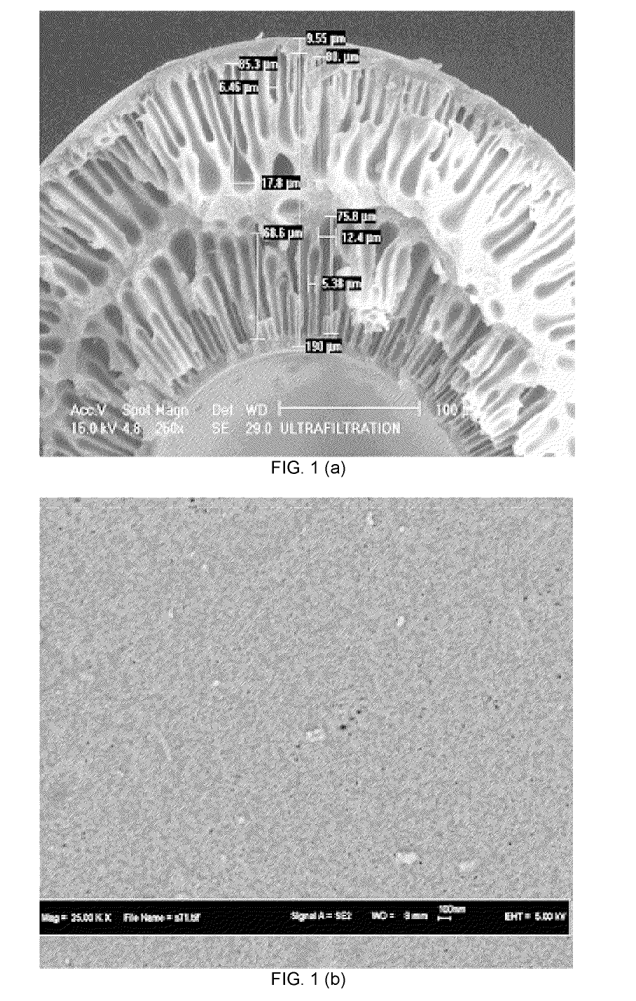

FIG. 1 shows the SEM images of clean bio-membrane hollow fiber. The as-spun bio-membrane PSF membrane from the phase inversion process exhibited typical asymmetric structure with developed macro pores and finger like structures that acted as micro porous mechanical support. In particular the asymmetric membrane showed pronounce morphologies with an apparent dense top layer ranges from 0.45 μm to 0.58 μm and porous sublayer which present in the form of sponge, finger like and macro voids structures. A finger like structure was evenly formed as shown by SEM. The cross section of the bio-membrane fiber showed a finger like structure that started from the outer edge of the nascent fiber to the middle of cross section. The outer edge cross section exhibited obvious morphological differences between a dense active layer and supported micro porous structures with no visible pores can be seen at magnification of 25000×. On the other hand, the inner edge cross section showed uniform micro porous pores network which apparently suggested that the membrane had an outer skin layer. This morphological characteristic occurred due to a convective forced instantaneous phase separation by nitrogen air that happened from the outer surface of the nascent fiber upon extruding from the spinneret. The demixing of dope solution was even faster when the fiber went through the outer coagulation bath as water was a stronger coagulant which speed-up the instantaneous phase separation towards the inner surface. Therefore the evolved membrane morphology is obviously dependent on the employed convective force, coagulant, polymer and solvent of spinning solution which were potential in influencing the phase separation pace as well as the membrane performance.

Bio-Membrane's Dope Preparation

The bio-membrane spun in this study is asymmetric type that involves formulation of a homogeneous multi-component solution known as a dope. Bio-membrane's dope comprises a polymer, solvent and additive polymer. Dope formulation has been designed to produce a high performance polysulfone (PSF) membrane for water treatment. The dope composition for bio-membrane is shown in Table 1. The dope consisted polysulfone polymer (Udel-P3700) supplied by Amoco Performance Product Inc., additive polymer of polyvinyl-pyrolidone PVP-K30 (Fluka Milwaukee) and solvent N,N-dimethylacetamide (DMAc) that was purchased from Merck Darmstadt Germany.

TABLE 1
Dope formulation for bio-membrane

| Material | Concentration |
|---|---|
| Polymer; Polysulfone (Udel-P3700) | 15%-18% |
| Solvent; N,N-dimethylacetamide (Merck) | 65%-70% |
| Additive; poly (vinyl-pyrolidone)-K30 (Fluka) | 10%-15% |

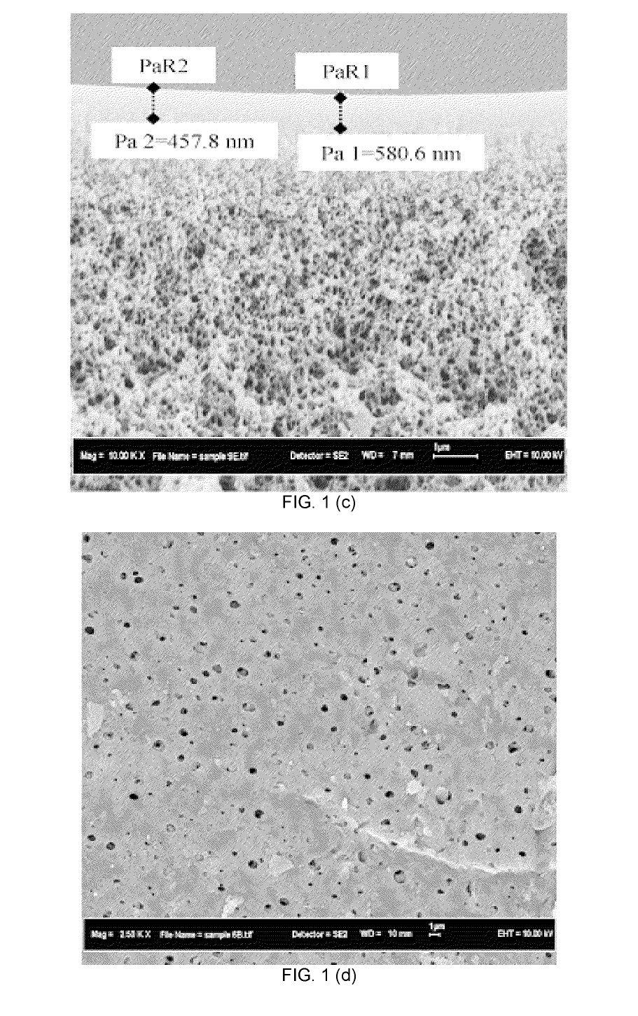

The PSF polymer was chosen as membrane material due to wide commercial application, commercial availability and favarouble rejection-flux decline characteristics. All organic chemicals were used as received except the polymer which was preliminary dried to remove any moisture contents. Adsorbed moisture from surrounding may deteriorate the polymer dope solution as it would act as a non solvent behavior. The polymer, solvent and additive are sequentially mixed into a stirring container (FIG. 2) until a homogenous mixture is achieved. The operation temperature was carefully controlled at constant temperature below the polymer T_{g} value. Operating temperature was generated by heating mantle and controlled through condenser and thermometer. Optimal temperature controlled and stirrer speed would enhance the dissolution and homogeneity of the dope solution. Polymer and solvent was initially mixed in the container prior to the addition of additive. Only a small quantity of polymer pellet (˜20 mg) was added into glass vessel in order to attain better mixture dissolution and as well as to avoid polymer agglomeration. Subsequently polymeric additive was added into the solution until a homogeneous mixture as achieved. Finished membrane dope solution was later treated by ultrasonic water bath to purge any trapped micro bubbles.

Hollow Fiber Membrane Spinning

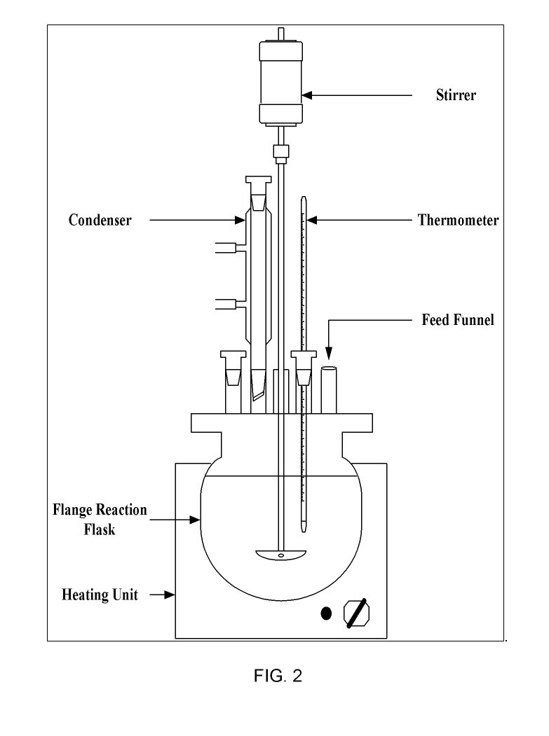

In general the dry/wet spinning process involves extrusion of spinning solution and co-extrusion of bore fluid through a spinneret die to produce a nascent cylindrical hollow fiber. The bio-membrane was fabricated using a dry/wet spinning rig. The extruded hollow fiber is immersed into a non-solvent precipitation bath through a spin line of 15 cm air gap. The formulated bio-membrane's dope was spun using dry/wet spinning process under pressurized nitrogen gas in the dry gap as shown in FIG. 3.

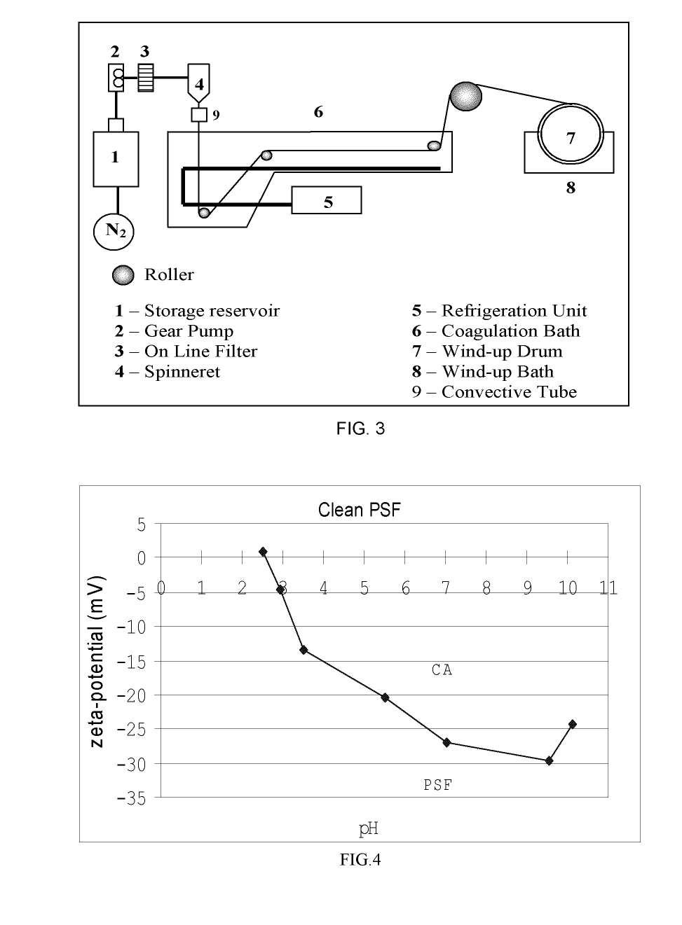

FIG. 4 shows the zeta potential curve of PSF bio-membrane. The iso-electric point (ISP) of the bio-membrane is found to present at pH 2.5. Incremental of pH has virtually resulted the membranes in becoming more negatively charged over the entire pH range. In fact the synthesized bio-membrane has been proven to possess zeta potential of −27 mV@pH 7.

Dope solution pressure was constantly maintained at 14.2 PSI in order to prevent any occurrence of cavitation in the pump line. This process has been shown to successfully produce an asymmetric membrane which possesses a thin selective skin with a micro porous substructure support.

Dry/Wet Spinning Process

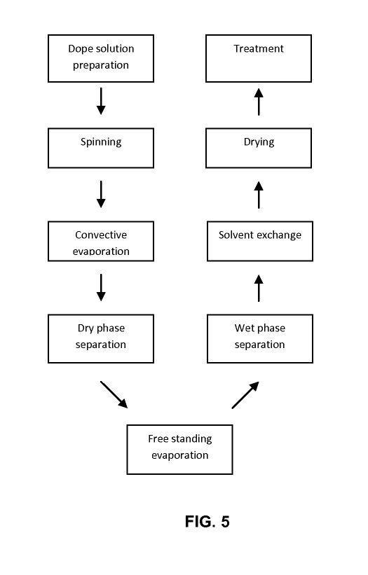

Membrane spinning process was carried out at ambient atmosphere 25° C. and 84% relative humidity. FIGS. 3 and 5 show the experimental work for dry/wet spinning process. Bio-membrane was spun at selected dope extrusion rate (DER) followed by a forced convective evaporation which further enhances the dry phase separation. DER is known as volumetric flow rate of polymer solution which reflects the shear experienced by the dope solution in the spinning line. Nitrogen gas was flushed (0.1 L/min) to the nascent fiber in the forced convection chamber (5 cm diameter and 9 cm height). Exposed to nitrogen sped up the solvent evaporation and induced faster phase separation to the outer morphology of the fiber surface. The dope was smoothly pumped into the tube-in-orifice spinneret by a 30 Watt gear pump motor (0.3 cm³/rev) and with a dope extrusion rates (DERs) ranging from 3.0-3.5 cm³/min. Bore fluid of deionized water was hydraulically injected into the central spinneret capillary section at a constant flowrate (1.0-1.17 cm³/min) by a pulse-free ISCO 500D syringe pump. Bore fluid flows in the annulus center to form hollow path known as lumen or fiber bore. Upon extrusion from the annular aperture of spinneret, the pre-nascent membrane passed through cylindrical hollow perspex before the force convective evaporation was induced by blowing nitrogen stream across the membrane surface. The as-spun fiber of bio-membrane would fall into the coagulation bath, subsequently a nascent skin layer was formed from a region with locally elevated polymer concentration due to a selective loss of highly volatile solvent from the outermost surface of freshly as-spun bio-membrane. The nascent skin layer is then immersed in a coagulation bath for wet phase separation; whereas tap water was used as a coagulation medium. At this moment the bulk of membrane structure is formed by counter-diffusion of solvents and non-solvents. Coagulation bath temperature is controlled between 10-14° C. by refrigeration to ensure rapid solidification whereas the washing bath is maintained at ambient temperature. The hollow fiber filament is mechanically collected by a wind-up drum (17 cm diameter) with an applied jet stretch ratio (JS) constantly maintained at one. The jet stretch is the ratio of initial fiber velocity to the take up drum velocity and is technically defines as shown in Equation 1 below.

JS=Vf/(DER/Aₛₚ)=V_{f}/Vₒ (1)

where Aₛₚ is the spinneret cross sectional.

The spun hollow (HF) fibers of bio-membrane are then rinsed thoroughly with water to remove residual solvent. The fibers are then soaked with post treatment solution and air-dried in room temperature prior to usage.

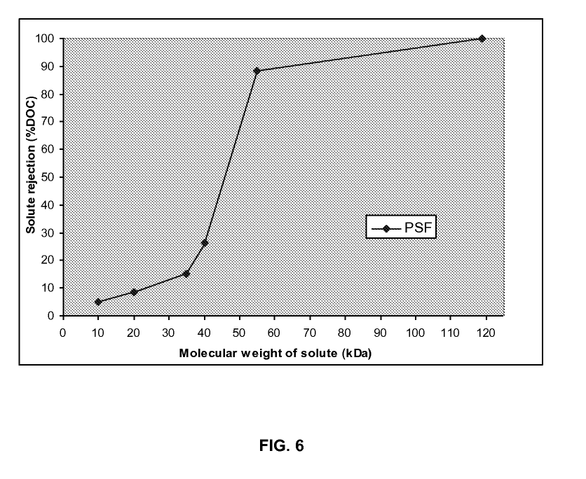

It was observed that in FIG. 6 the solute separation of bio-membrane increased almost linearly with increase in molecular weight of solutes, thus apparently reflecting to a diffuse type of cut-off. The nominal MWCO of the membrane has been determined using a series filtration of known relative molecular mass (RMM) between 10 kDa to 119 kDa (PEG and PVP). The MWCO is typically defined as the RMM of non-charged macromolecules model compounds that is 90% rejected by the membrane.

PSF polymer has been chosen as the membrane polymer due to its higher physical, mechanical and chemical stability compared to other polymer such as polyamide and cellulose acetate. While UDEL is the commercial name of PSF polymer that was bought. Other polymer can also be substituted but this may lead to undesired membrane characteristic and performance in term of hydrophobicity, molecular weight cut-off (MWCO), surface charge, fouling behaviours, permeate quality and membrane productivity. Below (Table 2) is the characteristic of PSF polymer.

TABLE 2
Physical, mechanical and chemical properties of PSF polymer

| Property | Average value |
|---|---|
| Molecular weight of repeat unit (g/mol) | 35400 |
| Density (g/cm³) | 1.24-1.25 g/cc |
| Glass transition temperature (° C.) | 188-190° C. |
| Tensile strength (MPa) | (20-97 MPa) |
| Tensile modulus (GPa) | 2.48-2.7 GPa |
| Elongation at break (%) | 10-75% |
| Thermal conductivity (W/m.K) | 0.12-0.26 W/m-k |
| Coefficient of linear thermal expansion (μm/m. ° C.) | 55-100 μm/m-° C.) |

1. A bio-membrane formulation to be used to eliminate microorganism, turbidity, suspended particles and organic matters from drinking water wherein the bio-membrane includes a polysulfone with a concentration of 15%-18%, N,N-dimethylacetamide (DMAc) of 65%-70% and poly (vinyl-pyrolidone)-K30 at 10%-15%.

2. The bio-membrane formulation as claimed in claim 1, wherein the formulation is synthesized from phase inversion technique using a dry-wet spinning machine.

3. A use of the bio-membrane as a filter for purifying drinking water.
